(19) United States
(12) Patent Application Publication
(10) Pub. No.: US 2022/0244368 A1
(43) Pub. Date: Aug. 4, 2022

(54) METHOD FOR DETECTING A PRESENCE OF AT LEAST ONE LIVING BEING INSIDE A CABIN OF A VEHICLE, SYSTEM OF A VEHICLE, COMPUTER PROGRAM PRODUCT AND COMPUTER-READABLE DATA CARRIER

(71) Applicant: Hella GmbH & Co. KGaA, Lippstadt (DE)

(72) Inventors: Zeid ABOU-CHAHINE, Lippstadt (DE); Henning IRLE, Lippstadt (DE)

(73) Assignee: Hella GmbH & Co. KGaA, Lippstadt (DE)

(21) Appl. No.: 17/725,265

(22) Filed: Apr. 20, 2022

Related U.S. Application Data
(63) Continuation of application No. PCT/EP2020/056901, filed on Mar. 13, 2020.

(30) Foreign Application Priority Data
Oct. 21, 2019 (DE) 10 2019 128 332.9

(51) Int. Cl. G01S 13/04; B60R 21/015; G01S 13/88

(52) U.S. Cl. CPC G01S 13/04; G06F 3/017; G01S 13/886; B60R 21/01534

(57) ABSTRACT

A method and system for detecting a presence of at least one living being inside a cabin of a vehicle by radio signals. At least one transmission signal is transmitted from at least one transmission unit positioned at a transmission unit position inside the cabin towards a surveillance area of an interior of the cabin. Receiving responding signals from the surveillance area caused by a reflection of the transmission signal in the surveillance area with at least two receiving units each positioned at a receiving unit position inside the cabin, whereat all of the receiving unit positions are placed apart from each other and the responding signals are being received by anyone of the receiving units. Evaluating of the responding signals and detecting the presence of the living being in the surveillance area and triggering an action of at least one actuator of the vehicle.

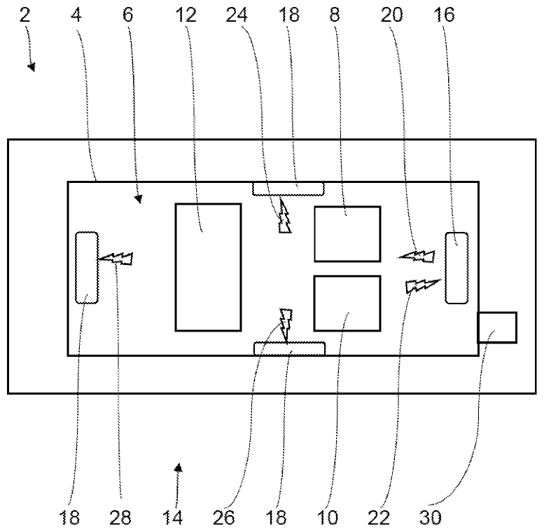

This nonprovisional application is a continuation of International Application No. PCT/EP2020/056901, which was filed on Mar. 13, 2020, and which claims priority to German Patent Application No. 10 2019 128 332.9, which was filed in Germany on Oct. 21, 2019, and which are both herein incorporated by reference.

### BACKGROUND OF THE INVENTION

### Field of the Invention

The present invention relates to a method for detecting a presence of at least one living being inside a cabin of a vehicle, a system of a vehicle for detecting a presence of at least one living being inside a cabin of the vehicle, a computer program product and a computer-readable data carrier.

### Description of the Background Art

Methods, systems, computer program products and computer-readable data carriers are already known in different embodiments.

Known methods for detecting a presence of at least one living being inside a cabin of a vehicle, systems of a vehicle for detecting a presence of at least one living being inside a cabin of the vehicle, computer program products and a computer-readable data carriers are engaging radar systems, cameras, capacitive sensors as well as systems combining the aforementioned technologies. Such systems are quite complicated to handle and expensive.

### SUMMARY OF THE INVENTION

It is therefore an object of the present invention to provide a method for detecting a presence of at least one living being inside a cabin of a vehicle, a system of a vehicle for detecting a presence of at least one living being inside a cabin of the vehicle, a computer program product and a computer-readable data carrier at a lower cost. Furthermore, by using the invention instead of using a camera privacy concerns have not to be handled with.

The inventive method for detecting a presence of at least one living being inside a cabin of a vehicle by means of radio signals, comprises the following steps: Transmitting at least one transmission signal from at least one transmission unit positioned at a transmission unit position inside the cabin towards a surveillance area of an interior of the cabin; Receiving responding signals from the surveillance area caused by a reflection of the transmission signal in the surveillance area with at least two receiving units each positioned at a receiving unit position inside the cabin, whereat all of the receiving unit positions are placed apart from each other and the responding signals are being received by anyone of the receiving units; Evaluating of the responding signals by means of an evaluation unit, whereat the evaluation unit is linked to the at least one transmission unit and the at least two receiving units in a signal transmitting manner; Detecting the presence of the living being in the surveillance area of the interior according to the evaluation of the responding signals in the evaluation unit and triggering an action of at least one actuator of the vehicle according to the detection of the presence of the living being.

Furthermore, the inventive system of a vehicle for detecting a presence of at least one living being inside a cabin of the vehicle by means of radio signals comprises at least one transmission unit positioned at a transmission unit position inside the cabin designed and configured for transmitting at least one transmission signal towards a surveillance area of an interior of the cabin, at least two receiving units each positioned at a receiving unit position inside the cabin designed and configured for receiving responding signals from the surveillance area, each caused by a reflection of the transmission signal in the surveillance area, whereat all of the receiving unit positions are placed apart from each other and the responding signals are being received by anyone of the receiving units, an evaluation unit designed and configured for evaluating the responding signals in order to detect the presence of the living being in the surveillance area of the interior, whereat the evaluation unit is linked to the at least one transmission unit and the at least two receiving units in a signal transmitting manner, and at least one actuator, whereat the actuator is designed and configured to be triggered according to the detection of the presence of the living being.

The responding signals triggered by the at least one transmission signal depend on the living being to be detected as well as on the properties of so-called communication channels, thus areas between the transmission unit and the living being on one side and between the living being and the receiving units on the other side. These communication channels mainly depend on the properties of a medium between antennas of the at least one transmission unit and the receiving units including the direct path and reflected multipaths due to living beings and/or nonliving objects, which is dynamic and directly dependent on the geometry, positioning and materials of the medium in between the aforementioned antennas of the transmission unit and the receiving units. The evaluated responding signals will be reflected from everything in between. In case of living beings, the responding signals will be often a combination of multipath signals that reflect not just from the living beings. The responding signals are therefore a combination of several reflections. Also, one may think of a technique where before a living being is entering the vehicle, the responding signals depending on the communication channels are also being evaluated. During and after entering of the living being, the properties of the communication channels will be different and therefore this change will be detectable. Thus, the evaluation of the responding signals in the evaluation unit will yield different results depending on whether or not at least one living being is in the surveillance area of the interior of the vehicle. That way, a presence of the at least one living being can be detected.

An advantage of the inventive method for detecting a presence of at least one living being inside a cabin of a vehicle, the inventive system of a vehicle for detecting a presence of at least one living being inside a cabin of the vehicle, the inventive computer program product and the inventive computer readable-data carrier is, that the presence of at least one living being inside a cabin of a vehicle can be detected with less cost and by keeping the privacy of living beings detected without further actions. For example, radar systems or camera systems are quite expensive. The triggered action of at least one actuator of the vehicle according to the detection of the presence of the living being could be of any useful and suitable manner. For example, displaying an alert to the driver to make sure, that every occupant of the vehicle has fasten his or her seatbelt.

Thus, the wording “for detecting a presence of at least one living being inside a cabin of a vehicle” can also mean “for detecting an occupancy of at least one space in an interior of a cabin by at least one living being inside the cabin of a vehicle”. That means, with the invention not only a presence of at least one living being inside a cabin may be detected, but an occupancy of a certain space inside the cabin of the vehicle can be detected, too.

Of course, other systems of the vehicle can also be triggered. Another example is, that the actuator is built as a transmitter for transferring data from the vehicle to a cloud or another external receiver for further processing or statistics.

Further advantages developments of the inventive method, system, computer program product and computer-readable data carrier are apparent from the sub-claims as well as from the following description of an exemplary embodiment of the inventive method and system by means of the attached FIGURE.

A particular preferable development of the inventive method is, the at least one transmission signal and the responding signals are configured to use Bluetooth™ frequency bands and/or Bluetooth™ protocols and/or to use WiFi™ frequency bands and/or WiFi™ protocols. Hereby, the inventive method can be realized with well-known technologies, which are already widely used. This is especially advantages, if Bluetooth™ and/or WiFi™ is already installed in the vehicle and in use for other systems. Thus, existing technical systems of the vehicle can be used for also another purpose, namely for processing the inventive method. That means, no extra system has to be installed and configured, but an already existing system can be enhanced in its functionality.

In parallel, a particular preferably development of the inventive system is, the at least one transmission unit and the at least two receiving units are designed and configured to use Bluetooth™ frequency bands and/or Bluetooth™ protocols and/or to use WiFi™ frequency bands and/or WiFi™ protocols.

Another advantageous development of the method according to the invention is, that the surveillance area is covering at least a driver's seat of a driver of the vehicle, preferably the driver's seat and a front-seat passenger place of a front-seat passenger. That means, that at least the most important area or areas of the interior of the cabin is/are surveilled for the presence of a living being. For example, it is possible to find out about an occupancy of the driver's seat or the driver's seat and the front-seat passenger place by using the invention. Of course, the invention enables to detect an occupancy of other places for passengers, namely rear passengers' seats, too.

According to a further advantageous development of the inventive method, the evaluation of the responding signals is configured to detect a vital sign of the driver, preferably of all of the living beings detected, whereat the action of the actuator is being triggered according to the detection of the vital sign. Hereby, the safety of the vehicle and of other traffic participants is enhanced. For example, in case of a negative vital sign of the driver of the vehicle an alert can be transmitted to an outside of the vehicle in order to alert other traffic participants that a dangerous situation may occur.

A further preferable development of the method according to the invention is, that the evaluation of the responding signals is configured to detect a gesture of the driver, preferably of all of the living beings detected, whereat the action of the actuator is being triggered according to the detection of the gesture. That way an alertness of the driver can be recognized. If an alertness of the driver is detected to be not sufficient for driving the vehicle, a visual and/or acoustic alert can be given to the driver by using a common human machine interface of the vehicle. Furthermore, it is possible to control certain functions of the vehicle by doing specific gestures.

The function of the transmitting unit and/or receiving units can be of any suitable manner.

A further preferably development of the system according to the invention is, that the transmission unit is designed and configured as one of the receiving units or one of the receiving units is designed and configured as the transmission unit. That way, the transmission unit or one of the receiving units is used in a double function, namely as the transmitter and as one of the receivers. Thus, the equipment needed is reduced and the cost for realizing the inventive system, too.

Another advantageous development of the system according to the invention is, that the receiving unit positions are positioned even over the interior, preferably at peripheral positions of the interior. Hereby, the surveillance area is surveilled from different positions. Furthermore, the communication channels to each of the receiving units are influenced in different ways by the at least one living being detected by the system, which enhances the detection of the at least one living being as well as the detection of the vital sign and/or the gesture of the living being, too.

Still another advantageous development of the system according to the invention is, that the transmission unit is positioned at a front of the interior, preferably at a peripheral position of the interior. That way, the transmission unit is positioned in a very advantageous manner with respect to the transmission of the transmitting signal to the surveillance area with respect to the driver's seat. Thus, the very important driver's seat is surveilled by the inventive system in a very accurate manner.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein the sole FIGURE schematically illustrates an exemplary embodiment of the system according to the invention.

### DETAILED DESCRIPTION

In the FIGURE a vehicle 2 is displayed, whereat the vehicle 2 is designed as an automobile. The vehicle 2 comprises a cabin 4 with an interior 6 inside the cabin 4, whereat a driver's seat 8 for a driver of the vehicle 2, a front passenger seat 10 for a passenger and rear seats 12 for further passengers of the vehicle 2 are mounted inside the cabin 4. Furthermore, the vehicle 2 comprises a system 14 for detecting a presence of at least one living being inside the cabin 4 by means of radio signals, positioned in the interior 6 of the cabin 4. The aforementioned driver and passengers are not displayed in the FIGURE.

The system 14 for detecting a presence of at least one living being inside the cabin 4 by means of radio signals comprises one transmission unit 16 positioned at a transmission unit position inside the cabin 4 designed and configured for transmitting at least one transmission signal towards a surveillance area of the interior 6 of the cabin 4 and three receiving units 18 each positioned at a receiving unit position inside the cabin 4 each designed and configured for receiving responding signals from the surveillance area each caused by a reflection of the transmission signal in the surveillance area, whereat all of the receiving unit positions 18 are placed apart from each other and the responding signals are being received by anyone of the receiving units 18.

The transmission unit 16 may be designed and configured as one of the receiving units, too. Thus, the transmission unit 16 is also designed and configured for receiving the responding signals from the surveillance area, caused by a reflection of the transmission signal in the surveillance area. Thus, in total there are four receiving units 16, 18 positioned in the interior 6 inside the cabin 4.

As can be seen from the FIGURE, all of the receiving units 16, 18 are positioned even over the interior 6, namely at peripheral positions at a front, a rear and on two sides of the interior 6 of the cabin 4. The transmitting unit 16 is positioned at the front of the interior 6 of the cabin 4, whereas the receiving units 18 are positioned at the rear and the two sides of the interior 6 of the cabin 4 of the vehicle 2.

The transmission signal is symbolized in the FIGURE by an arrow 20 and the responding signals are symbolized in the FIGURE by arrows 22, 24, 26, 28.

The transmission unit 16 and the receiving units 18 are each designed and configured to use WiFi™ frequency bands and/or WiFi™ protocols. Of course, in other embodiments of the invention, the transmission unit and the at least two receiving units can be designed and configured to use Bluetooth™ frequency bands and/or Bluetooth™ protocols or to use Bluetooth™ frequency bands and/or Bluetooth™ protocols and WiFi™ frequency bands and/or WiFi™ protocols, too.

Furthermore, the system 14 comprises an evaluation unit 30 designed and configured for evaluating the responding signals 22, 24, 26, 28 in order to detect the presence of the living being in the interior 6, whereat the evaluation unit 30 is linked to the transmission unit 16 and the receiving units 18 in a signal transmitting manner, and at least one actuator, whereat the actuator is designed and configured to be triggered according to the detection of the presence of the living being. The actuator is not displayed in the FIGURE. The evaluation unit 30 is designed and configured to process the responding signals 22, 24, 26, 28 according to the following:

The responding signals 22, 24, 26, 28 triggered by the at least one transmission signal 20 depend on the living being to be detected as well as on the properties of so-called communication channels, thus areas between the transmission unit 16 and the living being on one side and between the living being and the receiving units 16, 18 on the other side. These communication channels mainly depend on the properties of a medium between antennas of the at least one transmission unit 16 and the receiving units 16, 18 including the direct path and reflected multipaths due to living beings and/or nonliving objects, which is dynamic and directly dependent on the geometry, positioning and materials of the medium in between the aforementioned antennas of the transmission unit 16 and the receiving units 16, 18. The evaluated responding signals 22, 24, 26, 28 will be reflected from everything in between. In case of living beings, the responding signals 22, 24, 26, 28 will be often a combination of multipath signals that reflect not just from the living beings. The responding signals 22, 24, 26, 28 are therefore a combination of several reflections. Also, one may think of a technique where before a living being is entering the vehicle 30, the responding signals 22, 24, 26, 28 depending on the communication channels are also being evaluated. During and after entering of the living being, the properties of the communication channels will be different and therefore this change will be detectable. Thus, the evaluation of the responding signals 22, 24, 26, 28 in the evaluation unit 30 will yield different results depending on whether or not at least one living being is in the surveillance area of the interior 6 of the vehicle 2. That way, a presence of the at least one living being in the surveillance area of the interior 6 of the vehicle 2 can be detected.

The antennas of the transmitting unit 16 and of the receiving units 18 are not displayed in the FIGURE.

In the following, the function of the inventive system and the method according to the invention are explained in detail by means of the embodiment displayed by the FIGURE.

The driver of the vehicle 2 enters the cabin 4 of the vehicle 2 and sits down on the driver's seat 8 of the vehicle 2. The driver starts an engine of the vehicle 2 and drives away. The engine is not displayed in the FIGURE. Meanwhile, the system 14 of the vehicle 2 processes the method according to the invention for detecting a presence of at least one living being inside the cabin 4 of the vehicle 2 by means of radio signals, namely by using WiFi™ frequency bands and/or WiFi™ protocols, comprising the following steps: Transmitting the transmission signal 20 from the transmission unit 16 positioned at the transmission unit position inside the cabin 4 towards the surveillance area of the interior 6 of the cabin 4 and receiving responding signals 22, 24, 26, 28 from the surveillance area caused by the reflection of the transmission signal 20 in the surveillance area of the interior 6, for example, the driver sitting on the driver's seat 8 with the receiving units 18, each positioned at the receiving unit position inside the cabin 4, and the transmitting unit 16, which is designed and configured as a receiving unit, too. Thus, the surveillance area of the system 14 covers at least a place of the driver's seat 8 of the vehicle 2. Preferably, the surveillance area covers not only the place of the driver's seat 8 but a front-seat passenger place of a front-seat passenger or all places of passengers, too. Because of all of the receiving unit positions and the transmission unit position are placed apart from each other and the responding signals 22, 24, 26, 28 are being received by anyone of the receiving units 16, 18, all of the responding signals 22, 24, 26, 28 received by the receiving units 16, 18 are different to each other due to the aforementioned conditions of the communication channels.

After the responding signals 22, 24, 26, 28 were received by the receiving units 16, 18, the responding signals 22, 24, 26, 28 are evaluated by means of the evaluation unit 30, whereat the evaluation unit 30 is linked to the transmission unit 16 and the receiving units 18 in a signal transmitting manner, which is state of the art and not further explained. The evaluation of the responding signals 22, 24, 26, 28 is processed according to the aforementioned conditions of the communication channels. Hereby, an already existing transmitting unit and already existing receiving units of the vehicle 2 can be used for the function of the inventive method. Thus, no extra transmitting unit 16 and/or receiving units 18 are necessary for implementing the inventive method. Because of the fact, that the driver is sitting on the driver's seat 8 of the vehicle 2, the presence of the driver in the interior 6 according to the evaluation of the responding signals 22, 24, 26, 28 in the evaluation unit 30 is detected. According to the detected presence of the driver in the surveillance area of the interior 6 of the cabin 4 of the vehicle 2, an action of the actuator of the vehicle 2 is triggered. For example, the action can be designed and configured as a visual and/or acoustic alert informing the driver to fasten his or her seat belt. Of course, other actuators and other functions of the vehicle 2 can be triggered by the aforementioned detected presence of the driver, too.

Because of the inventive method and the inventive system for processing the inventive method according to the aforementioned embodiment, a presence of at least one living being inside the cabin 4 of the vehicle 2 can be detected with less cost and by keeping the privacy of living beings detected without further actions. The triggered action of at least one actuator of the vehicle according to the detection of the presence of the living being could be of any useful and suitable manner. For example, displaying an alert to the driver to make sure, that every occupant of the vehicle has fasten his or her seatbelt. Thus, the detection of a presence of at least one living being inside the cabin 4 of the vehicle 2 means a detection of an occupancy of at least one space in the interior 6 of the cabin 4 by at least one living being inside the cabin 4 of the vehicle 2. That means, with the invention according to the embodiment not only a pure presence of at least one living being inside the cabin 4 is being detected, but an occupancy of a certain space inside the cabin 4 of the vehicle 2 is being detected, too. Of course, other systems of the vehicle can be triggered, too.

The invention is not limited to the exemplary embodiment of the inventive method and the inventive system discussed before.

The invention can be advantageously used in other types of vehicles, too.

According to a further embodiment of the inventive method, the evaluation of the responding signals is configured to detect a vital sign of the driver, preferably of all of the living beings detected, whereat the action of the actuator is being triggered according to the detection of the vital sign. Hereby, the safety of the vehicle and of other traffic participants is enhanced. For example, in case of a negative vital sign of the driver of the vehicle an alert can be transmitted to an outside of the vehicle in order to alert other traffic participants that a dangerous situation may occur.

Another embodiment of the method according to the invention is, that the evaluation of the responding signals is configured to detect a gesture of the driver, preferably of all of the living beings detected, whereat the action of the actuator is being triggered according to the detection of the gesture. That way an alertness of the driver can be recognized. If an alertness of the driver is detected to be not sufficient for driving the vehicle, a visual and/or acoustic alert can be given to the driver by using a common human machine interface of the vehicle. Furthermore, it is possible to control certain functions of the vehicle by doing specific gestures.

Moreover, an inventive computer program product may comprise instructions which, when the program is executed by the system according to the invention, carries out the method according to the invention. A computer-readable data carrier according to the invention may store thereon the aforementioned computer program product.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for detecting a presence of at least one living being inside a cabin of a vehicle via radio signals, the method comprising:
transmitting at least one transmission signal from at least one transmission unit positioned at a transmission unit position inside the cabin towards a surveillance area of an interior of the cabin;
receiving responding signals from the surveillance area caused by a reflection of the transmission signal in the surveillance area with at least two receiving units positioned at a receiving unit position inside the cabin, wherein all of the receiving unit positions are placed apart from each other and the responding signals are received by at least one of the receiving units;
evaluating the responding signals via an evaluation unit, wherein the evaluation unit is linked to the at least one transmission unit and the at least two receiving units in a signal transmitting manner;
detecting the presence of the living being in the surveillance area of the interior according to the evaluation of the responding signals in the evaluation unit; and
triggering an action of at least one actuator of the vehicle according to the detection of the presence of the living being.

2. The method according to claim 1, wherein the at least one transmission signal and the responding signals are configured to use Bluetooth™ frequency bands and/or Bluetooth™ protocols and/or to use WiFi™ frequency bands and/or WiFi™ protocols.

3. The method according to claim 1, wherein the surveillance area is covering at least a driver's seat of a driver of the vehicle or the driver's seat and a front-seat passenger seat of a front-seat passenger.

4. The method according to claim 1, wherein the evaluation of the responding signals is configured to detect a vital sign of the driver, preferably of all of the living beings detected, whereat the action of the actuator is being triggered according to the detection of the vital sign.

5. The method according to claim 1, wherein the evaluation of the responding signals is configured to detect a gesture of the driver, preferably of all of the living beings detected, and wherein the action of the actuator is being triggered according to the detection of the gesture.

6. A system for a vehicle to detect a presence of at least one living being inside a cabin of the vehicle via a radio signal, the system comprising:
at least one transmission unit arranged at a transmission unit position inside the cabin designed and configured for transmitting at least one transmission signal towards a surveillance area of an interior of the cabin;
at least two receiving units each positioned at a receiving unit position inside the cabin designed and configured for receiving responding signals from the surveillance area, each caused by a reflection of the transmission signal in the surveillance area, all of the receiving unit positions being placed apart from each other and the responding signals are received by at least one of the receiving units;
an evaluation unit to evaluate the responding signals in order to detect the presence of the living being in the surveillance area of the interior, the evaluation unit being linked to the at least one transmission unit and the at least two receiving units in a signal transmitting manner; and
at least one actuator configured to be triggered according to the detection of the presence of the living being.

7. The system according to claim 6, wherein the at least one transmission unit and the at least two receiving units are designed and configured to use Bluetooth™ frequency bands and/or Bluetooth™ protocols and/or to use WiFi™ frequency bands and/or WiFi™ protocols.

8. The system according to claim 6, wherein the transmission unit is designed and configured as one of the receiving units or one of the receiving units is designed and configured as the transmission unit.

9. The system according to claim 6, wherein the receiving unit positions are positioned even over the interior or at peripheral positions of the interior.

10. The system according to claim 6, wherein the transmission unit is positioned at a front of the interior or at a peripheral position of the interior.

11. A computer program product comprising instructions which, when the program is executed by a system cause the system to carry out the method of claim 1.

12. A computer-readable data carrier having stored thereon the computer program product according to claim 11.
